(19) United States
(12) Patent Application Publication
(10) Pub. No.: US 2024/0215008 A1
(43) Pub. Date: Jun. 27, 2024

(54) METHOD OF BANDWIDTH PART (BWP) SWITCHING AND RELATED APPARATUS

(71) Applicant: BEIJING UNISOC COMMUNICATIONS TECHNOLOGY CO., LTD., Beijing (CN)

(72) Inventor: Hualei WANG, Beijing (CN)

(21) Appl. No.: 18/291,358

(22) PCT Filed: Dec. 13, 2021
(86) PCT No.: PCT/CN2021/137531

§ 371 Date: Jan. 23, 2024

(30) Foreign Application Priority Data
Jul. 23, 2021 (CN) 202110837576.3

(51) Int. Cl. H04W 72/0457; H04L 43/0811; H04W 72/1273; H04W 74/0833

(52) U.S. Cl. CPC H04W 72/0457; H04L 43/0811; H04W 72/1273; H04W 74/0833

(57) ABSTRACT

A method of bandwidth part (BWP) switching and related apparatus are disclosed in embodiments of the disclosure. The method includes the following. A terminal device starts/restarts a timer associated with multiple active BWPs in a cell when any active BWP of the multiple active BWPs satisfies a starting/restarting condition of the timer. The terminal device switches from the multiple active BWPs to a default downlink BWP or an initial downlink BWP when the timer expires.

### CROSS-REFERENCE TO RELATED DISCLOSURE(S)

The application is a National Stage of International Application No. PCT/CN2021/137531, field Dec. 13, 2021, which claims priority to Chinese Patent Application No. 202110837576.3, field Jul. 23, 2021, the entire disclosure of which are incorporated herein by reference.

### TECHNICAL FIELD

The present disclosure relates to the field of communication technologies, and in particular, to a method of bandwidth part (BWP) switching and related apparatus.

### BACKGROUND

Currently, a cell in which a terminal device is located may be configured with multiple bandwidth parts (BWPs) by a network device. In order to improve throughput rate and reduce time delay, or improve the utilization rate of BWP, multiple BWPs in an active state may be supported in a communication system, i.e., multiple active BWPs exist at the same time.

However, multiple active BWPs bring a problem of high power consumption of the terminal device. In this case, how to maintain the communication performance while taking into account the power consumption of the terminal device is one of the problems to be solved.

### SUMMARY

In a first aspect, a method of bandwidth part (BWP) switching is provided in embodiments of the disclosure. The method includes the following. A terminal device starts/restarts a timer associated with multiple active BWPs in a cell when any active BWP of the plurality of active BWPs satisfies a starting/restarting condition of the timer. The terminal device switches from the multiple active BWPs to a default downlink BWP or an initial downlink BWP
switching, by the terminal device, from the plurality of active BWPs to a default downlink BWP or an initial downlink BWP when the timer expires.

In a second aspect, a method of BWP switching is provided in embodiments of the disclosure. The method includes the following. A terminal device starts/restarts a timer associated with an active BWP in a cell when the active BWP satisfies a starting/restarting condition of the timer. The terminal device switches from the active BWP to a default downlink BWP or an initial downlink BWP when the timer expires.

In a third aspect, a terminal device is provided in embodiments of the disclosure. The terminal device includes a memory and a processor. The memory is configured to store a computer program. The processor is configured to execute the computer program to start/restart a timer associated with an active BWP in a cell when the active BWP satisfies a starting/restarting condition of the timer. The processor is further configured to switch from the active BWP to a default downlink BWP or an initial downlink BWP when the timer expires.

### BRIEF DESCRIPTION OF THE DRAWINGS

FIG. 1 is a schematic structural diagram of a communication system provided in embodiments of the disclosure.

FIG. 2 is a schematic flowchart of a method of bandwidth part (BWP) switching provided in embodiments of the disclosure.

FIG. 3 is a schematic flowchart of another method of BWP switching provided in embodiments of the disclosure.

FIG. 4 is a schematic structural diagram of an apparatus for BWP switching provided in embodiments of the disclosure.

FIG. 5 is a schematic structural diagram of a terminal device provided in embodiments of the disclosure.

### DETAILED DESCRIPTION

The following will describe embodiments of the disclosure with reference to the accompanying drawings in embodiments of the disclosure.

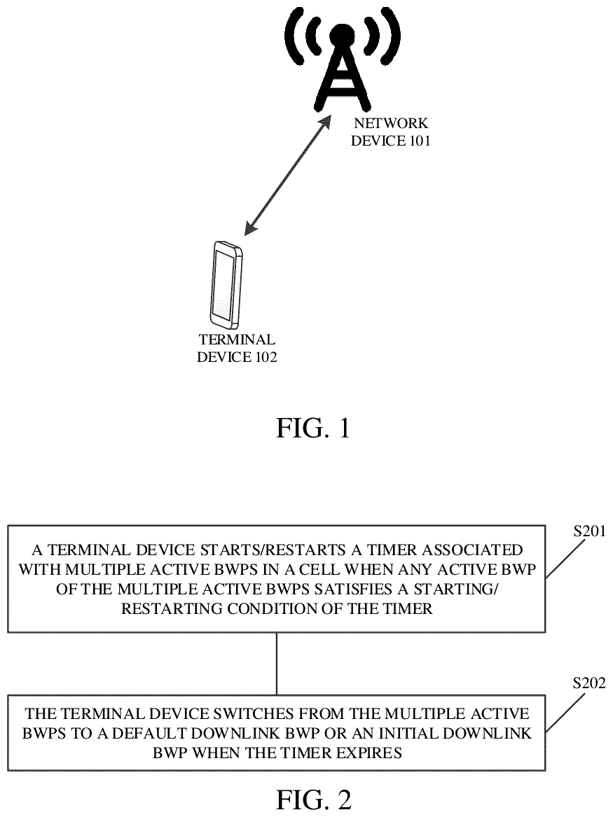

A communication system involved in embodiments of the disclosure is illustrated in FIG. 1. The communication system may include but is not limited to one network device and one terminal device. The quantity of devices and forms of the devices shown in FIG. 1 are used as examples, but do not constitute a limitation on this embodiment of this application. During actual application, the communication system may include more than one network device and more than one terminal device. The communication system shown in FIG. 1 is described by using an example in which there is a network device 101 and a terminal device 102, and the network device 101 can provide the terminal device 102 with network service, and the network device 101 can communicate with the terminal device 102. Embodiments of the disclosure may include other devices that can communicate with the network device 101 or the terminal device 102, which will not be limited herein.

The terminal device in embodiments of the disclosure may be called as a terminal, and may also be referred to as a user equipment (UE), an access terminal, a subscriber unit, a subscriber station, a mobile station (MS), a remote station, a remote terminal, a mobile device, a user terminal, a wireless communication device, a user agent, or a user device, etc. The terminal device may be a cellular radio telephone, a cordless telephone, a session initiation protocol (SIP) telephone, a wireless local loop (WLL) station, a personal digital assistant (PDA), a handheld device or a computing device with wireless communication functions, other processing devices coupled with a wireless modem, an in-vehicle device, a wearable device, and a terminal device in a 5th generation mobile communication system, or a terminal device in a future evolved public land mobile network (PLMN), etc., which will not be limited herein.

In embodiments of the disclosure, the network device is a physical entity connected to the network, and the network device includes a base station of access network and a base station controller.

In embodiments of the disclosure, the base station, also called as base station device, is a device deployed in a radio access network (RAN) to provide wireless communication functions. For example, in 2th generation mobile communication (2G) network, devices providing base station function include base transceiver station (BTS). In 3th generation mobile communication (3G) network, devices providing base station function include NodeB. In 4th generation communication (4G) network, devices providing base station function include evolved NodeB (eNB). In wireless local area networks (WLAN), device providing base station function is access point (AP). In 5G new radio (NR), devices providing base station function include gNB and ng-eNB, where terminal devices and gNB communicate using NR technology, and terminal devices and ng-eNB communicate using evolved universal terrestrial radio access (E-UTRA). Both gNB and ng-eNB can connected to the 5G core. Base stations provided in embodiments of the disclosure also include devices that provide base station function in new communication systems in the future.

In embodiments of the disclosure, the base station controller, also called as base station controller device, is a base station management device. For example, it may be a base station controller (BSC) in 2G network, a radio network controller (RNC) in 3G network, or a base station management device in new communication systems in the future.

The disclosure may be applicable to 5G communication system, and may also be applicable to 4G communication system, 3G communication system, and may also be applicable to a variety of communication systems in the future, such as 6th generation (6G) mobile communication, 7th generation (7G) mobile communication, etc., which will not be limited herein.

The disclosure is also applicable to different network architectures including, but not limited to, relay network architecture, dual link architecture, vehicle-to-everything (V2X) architecture, device-to-device (D2D) architecture, and the like.

In 3GPP release protocols such as R15, R16, and R17, for a bandwidth part (BWP), if a terminal device is configured with a default downlink BWP-identifier (ID) (defaultDownlinkBWP-id) by a network device, then the active BWP (BWP in an active state) is not a BWP indicated by the default downlink BWP-ID; if the terminal device is configured with a dormant BWP-ID by the network device, then the active BWP is not a BWP indicated by the dormant BWP-ID. If the terminal device is not configured with the default downlink BWP-ID by the network device, then the active BWP is not an initial downlink BWP; and if the terminal device is configured with the dormant BWP-ID by the network device, then the active BWP is not a BWP indicated by the dormant BWP-ID.

In addition, in R15, R16, and R17, a cell where a terminal device is located may be configured with multiple BWPs by a network device. However, only one BWP is active at any moment. For a timer-based BWP switching mechanism, when a timer associated with an active BWP expires, a terminal device switches from the active BWP to other BWP, so that the terminal device maintains communication continuity on another BWP and effectively reduces the power consumption of the terminal device.

There are four implementations of the starting/restarting condition of a timer associated with an active BWP.
1. A physical downlink control channel (PDCCH) indicating downlink assignment or uplink grant is received by the terminal device on the active BWP, and an ongoing random access procedure associated with a serving cell is successfully completed upon reception of the PDCCH addressed to a cell-radio network temporary identifier (C-RNTI) by the terminal device, or no ongoing random access procedure associated with the serving cell exists. The PDCCH indicating downlink assignment or uplink grant is addressed to a C-RNTI or a configured scheduling-radio network temporary identifier (CS-RNTI).

That is, one of the conditions for the terminal device to start/restart a timer associated with an active BWP includes the following. A PDCCH addressed to a C-RNTI or a CS-RNTI indicating downlink assignment or uplink grant is received on the active BWP, an ongoing random access procedure associated with this serving cell is successfully completed upon reception of this PDCCH addressed to a C-RNTI, or there is no ongoing random access procedure associated with this serving cell.
2. A PDCCH indicating downlink assignment or uplink grant is received by the terminal device for the active BWP, and an ongoing random access procedure associated with a serving cell is successfully completed upon reception of the PDCCH addressed to a C-RNTI by the terminal device, or no ongoing random access procedure associated with the serving cell exists. The PDCCH indicating downlink assignment or uplink grant is addressed to a C-RNTI or a CS-RNTI.

That is, one of the conditions for the terminal device to start/restart a timer associated with an active BWP includes the following. A PDCCH addressed to a C-RNTI or a CS-RNTI indicating downlink assignment or uplink grant is received for the active BWP, an ongoing random access procedure associated with this serving cell is successfully completed upon reception of this PDCCH addressed to a C-RNTI, or there is no ongoing random access procedure associated with this serving cell.
3. A medium access control (MAC) protocol data unit (PDU) is transmitted in a configured uplink grant and a listen before talk (LBT) failure indication is not received by the terminal device from layers lower than an MAC layer, and an ongoing random access procedure associated with a serving cell is successfully completed upon reception of the PDCCH addressed to a C-RNTI by the terminal device, or no ongoing random access procedure associated with the serving cell exists.

That is, one of the conditions for the terminal device to start/restart a timer associated with an active BWP includes the following. A MAC PDU is transmitted in a configured uplink grant and LBT failure indication is not received from lower layers, an ongoing random access procedure associated with this serving cell is successfully completed upon reception of this PDCCH addressed to a C-RNTI, or there is no ongoing random access procedure associated with this serving cell.
4. A MAC PDU is received by the terminal device in a configured downlink assignment, and an ongoing random access procedure associated with a serving cell is successfully completed upon reception of the PDCCH addressed to a C-RNTI by the terminal device, or no ongoing random access procedure associated with the serving cell exists.

That is, one of the conditions for the terminal device to start/restart a timer associated with an active BWP includes the following. If a MAC PDU is received in a configured downlink assignment, an ongoing random access procedure associated with this serving cell is successfully completed upon reception of this PDCCH addressed to a C-RNTI, or there is no ongoing random access procedure associated with this serving cell.

When the terminal device satisfies any one of the above four conditions on an active BWP, the terminal device starts/restarts a timer (i.e., bwp-InactivityTimer) associated with the active BWP. Moreover, the terminal device switches from the active BWP to a default downlink BWP indicated by a default downlink BWP-ID when the terminal device is configured with the default downlink BWP-ID and the timer expires. The terminal device switches from the active BWP to an initial downlink BWP when the terminal device is not configured with the default downlink BWP-ID and the timer expires. As such, the switching of the active BWP is realized by the terminal device. In this way, the terminal device can transmit data on the default downlink BWP or the initial downlink BWP after expiration of the timer, which can maintain the continuity of communication.

However, in order to improve throughput rate and reduce time delay, a cell with multiple BWPs in an active state may be supported in a future communication system (for example 7G system), which means part of BWPs, or all BWPs in a cell configured by a network device may be in an active state, i.e. multiple active BWPs exist at the same time.

However, the existence of multiple active BWPs may bring a problem of power consumption of the terminal. In this case, how to maintain the communication performance while taking into account the power consumption of the terminal device is one of the problems to be solved.

A method of BWP switching is provided in embodiments of the disclosure. The method includes the following. A terminal device starts/restarts a timer associated with multiple active BWPs in a cell when any active BWP of the multiple active BWPs satisfies a starting/restarting condition of the timer. The terminal device switches from the multiple active BWPs to a default downlink BWP or an initial downlink BWP when the timer expires. It can be seen that the terminal device may control the switching of multiple active BWPs through a timer to realize the switching of multiple active BWPs, thereby maintaining the communication performance while taking into account the power consumption of the terminal device. Further, the terminal device may maintain the continuity of communication when multiple active BWPs expire.

It is to be noted that, a group-radio network temporary identifier (G-RNTI) is a RNTI scheduled for the configuration of broadcast and/or multicast, and the specific naming will not be limited herein.

It is to be noted that, a configured scheduling-group-radio network temporary identifier (G-CS-RNTI) is a RNTI scheduled for the configuration of broadcast and/or multicast, and the specific naming will not be limited herein.

Based on the above description, a method of BWP switching illustrated in FIG. 2 is provided in embodiments of the disclosure. The method may include the following operations at S201-S202.

At S201, a terminal device starts/restarts a timer associated with multiple active BWPs in a cell when any active BWP of the multiple active BWPs satisfies a starting/restarting condition of the timer.

It is to be understood that, when multiple active BWPs exist in a cell (i.e. multiple BWPs are in an active state in a cell), the terminal device associates the multiple active BWPs with a timer, and the timer is configured to control the switching of the multiple active BWPs.

In addition, the terminal device starts/restarts the timer when any active BWP of the multiple active BWPs satisfies the starting/restarting condition of the timer, in order to monitor through the timer that whether the multiple active BWPs are available.

There are some implementations of the starting/restarting condition of the timer.
Implementation 1: A PDCCH indicating downlink assignment or uplink grant is received by the terminal device on any active BWP of multiple active BWPs, and an ongoing random access procedure associated with a serving cell is successfully completed upon reception of the PDCCH addressed to a C-RNTI or a G-RNTI by the terminal device, or no ongoing random access procedure associated with the serving cell exists. The PDCCH indicating downlink assignment or uplink grant is addressed to one of: a C-RNTI, a CS-RNTI, a G-RNTI, or a G-CS-RNTI.
Implementation 2: A PDCCH indicating downlink assignment or uplink grant is received by the terminal device for any active BWP of the multiple active BWPs, and an ongoing random access procedure associated with a serving cell is successfully completed upon reception of the PDCCH addressed to a C-RNTI or a G-RNTI by the terminal device, or no ongoing random access procedure associated with the serving cell exists. The PDCCH indicating downlink assignment or uplink grant is addressed to one of: a C-RNTI, a CS-RNTI, a G-RNTI, or a G-CS-RNTI.
Implementation 3: A MAC PDU is transmitted in a configured uplink grant and a LBT failure indication is not received by the terminal device from layers lower than an MAC layer, and an ongoing random access procedure associated with a serving cell is successfully completed upon reception of the PDCCH addressed to a C-RNTI or a G-RNTI by the terminal device, or no ongoing random access procedure associated with the serving cell exists.
Implementation 4: A MAC PDU is received by the terminal device in a configured downlink assignment, and an ongoing random access procedure associated with a serving cell is successfully completed upon reception of the PDCCH addressed to a C-RNTI or a G-RNTI by the terminal device, or no ongoing random access procedure associated with the serving cell exists.

That is, when multiple BWPs in a cell are in an active state and any active BWP of the multiple active BWPs satisfies the condition of one of the above implementation 1 to implementation 4, the timer associated with the multiple active BWPs will be started/restarted, in order to monitor the multiple active BWPs.

At 202, the terminal device switches from the multiple active BWPs to a default downlink BWP or an initial downlink BWP when the timer expires.

It is to be understood that, if the timer associated with the multiple active BWPs expires, it may mean that the bandwidth on the multiple BWPs is used up or there is no more data to be transmitted on the multiple active BWPs, i.e., the multiple active BWPs expire and the terminal device will not or cannot transmit data on the multiple active BWPs. Therefore, the terminal device switches from the multiple active BWPs to the default downlink BWP or the initial downlink BWP to continue the transmission of data on the default downlink BWP or the initial downlink BWP. In this way, the terminal device may avoid monitoring and/or transmitting on multiple expired BWPs (the multiple active BWPs) after expiration of the timer, thereby maintaining the communication performance while taking into account the power consumption of the terminal device. To sum up, the method can effectively reduce the power consumption of the terminal device while improving the communication performance.

In a possible embodiment, the terminal device switches from the multiple active BWPs to the default downlink BWP or the initial downlink BWP when the timer expires as follows. The terminal device switches from the multiple active BWPs to the default downlink BWP indicated by the default downlink BWP-ID when the terminal device is configured with the default downlink BWP-ID and the timer expires.

Since the terminal device is configured with the default downlink BWP-ID, the active BWP is not the default downlink BWP indicated by the default downlink BWP-ID, and the terminal device may switch from the multiple active BWPs to the default downlink BWP indicated by the default downlink BWP-ID when the timer associated with the multiple active BWPs expires, thereby realizing the switching of multiple active BWPs. In this way, the terminal device continues the transmission of data on the default downlink BWP, thereby reducing the power consumption of the terminal device.

In another possible embodiment, the terminal device switches from the multiple active BWPs to the default downlink BWP or the initial downlink BWP when the timer expires as follows. The terminal device switches from the multiple active BWP to the initial downlink BWP when the terminal device is not configured with the default downlink BWP-ID and the timer expires.

Since the terminal device is not configured with the default downlink BWP-ID by the network device, the active BWP is not the initial downlink BWP, and the terminal device may switch from the multiple active BWPs to the initial downlink BWP when the timer associated with the multiple active BWPs expires, thereby realizing the switching of the multiple active BWPs. In this way, the terminal device continues the transmission of data on the initial downlink BWP, thereby maintaining the continuity of communication and reducing the power consumption of the terminal device.

In embodiments of the disclosure, when multiple BWPs in a cell are in an active state, a terminal device associates the multiple active BWPs with a timer. The terminal device switches from the multiple active BWPs to a default downlink BWP or an initial downlink BWP when the timer expires. That is, the terminal device may realize the switching of multiple active BWPs through a timer, thereby avoiding the problem of the terminal device being unable to communicate on expired BWPs after expiration of the timer. In this way, the communication continuity of the terminal device may be maintained and the power consumption of the terminal device may be reduced.

A method 200 of BWP switching is further provided in embodiments of the disclosure. In the method, a terminal device associates each of multiple active BWPs in a cell with a timer respectively. For each active BWP, the terminal device deactivates the active BWP and switches from the active BWP to a default downlink BWP or an initial downlink BWP when the associated timer expires and there is no other active BWP. The terminal device deactivates the active BWP when the associated timer expires and there are other active BWPs. It may be seen that, the terminal device may associate an active BWP with a timer to realize the switching of one or more active BWPs, thereby maintaining the communication continuity of the terminal device while taking into account the power consumption of the terminal device.

Timers associated with the multiple active BWPs respectively have the same or different timing durations upon expiration, which will not be limited herein.

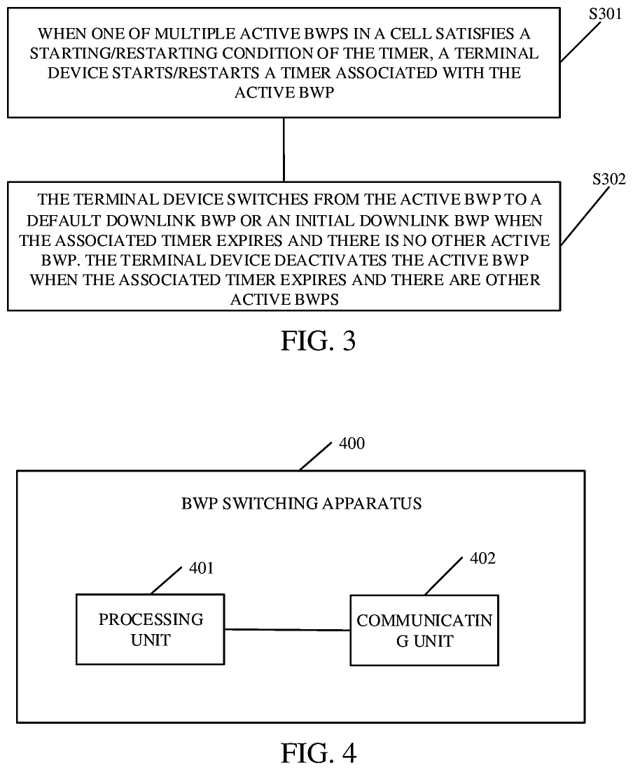

Based on the above description, a method of BWP switching illustrated in FIG. 3 is provided in embodiments of the disclosure. The method may include the following operations at S301-S302.

At S301, when one of multiple active BWPs in a cell satisfies a starting/restarting condition of the timer, a terminal device starts/restarts a timer associated with the active BWP.

It is to be understood that, when multiple active BWPs exist in a cell (i.e. multiple BWPs are in an active state in a cell), the terminal device associates each of the multiple active BWPs with a timer, i.e. one active BWP associates with a timer, and each timer is configured to control the switching or deactivation of the active BWP associated with the timer.

In addition, the terminal device starts/restarts the timer when any active BWP of the multiple active BWPs satisfies the starting/restarting condition of the timer, thereby monitoring through the timer that whether the active BWPs are available.

There are some implementations of the starting/restarting condition of the timer.
Implementation 1: A PDCCH indicating downlink assignment or uplink grant is received by the terminal device on the active BWP, and an ongoing random access procedure associated with a serving cell is successfully completed upon reception of the PDCCH addressed to a C-RNTI or a G-RNTI by the terminal device, or no ongoing random access procedure associated with the serving cell exists. The PDCCH indicating downlink assignment or uplink grant is addressed to one of: a C-RNTI, a CS-RNTI, a G-RNTI, or a G-CS-RNTI.
Implementation 2: A PDCCH indicating downlink assignment or uplink grant is received by the terminal device for the active BWP, and an ongoing random access procedure associated with a serving cell is successfully completed upon reception of the PDCCH addressed to a C-RNTI or a G-RNTI by the terminal device, or no ongoing random access procedure associated with the serving cell exists. The PDCCH indicating downlink assignment or uplink grant is addressed to one of: a C-RNTI, a CS-RNTI, a G-RNTI, or a G-CS-RNTI.
Implementation 3: A MAC PDU is transmitted in a configured uplink grant and a LBT failure indication is not received by the terminal device from layers lower than an MAC layer, and an ongoing random access procedure associated with a serving cell is successfully completed upon reception of the PDCCH addressed to a C-RNTI or a G-RNTI by the terminal device, or no ongoing random access procedure associated with the serving cell exists.
Implementation 4: A MAC PDU is received by the terminal device in a configured downlink assignment, and an ongoing random access procedure associated with a serving cell is successfully completed upon reception of the PDCCH addressed to a C-RNTI or a G-RNTI by the terminal device, or no ongoing random access procedure associated with the serving cell exists.

That is, when multiple BWPs in a cell are in an active state and any active BWP of the multiple active BWPs satisfies the condition of one of the above implementation 1 to implementation 4, the timer associated with the active BWP that satisfies the starting/restarting condition will be started/restarted, in order to monitor the active BWP.

At 302, the terminal device switches from the active BWP to a default downlink BWP or an initial downlink BWP when the associated timer expires and there is no other active BWP. The terminal device deactivates the active BWP when the associated timer expires and there are other active BWPs.

It is to be understood that, if the timer associated with any one of the multiple active BWPs expires, it may mean that the bandwidth on the active BWP is used up or there is no more data to be transmitted on the active BWP, i.e., the active BWP expires and the terminal device will not or cannot transmit data on the active BWP. Therefore, the active BWP is deactivated, which may effectively reduce the power consumption of the terminal device. When there is no other active BWP, the terminal device switches to the default downlink BWP or the initial downlink BWP to continue the transmission of data on the default downlink BWP or the initial downlink BWP. In this way, the terminal device may maintain the communication continuity. The terminal device switching to the default downlink BWP or the initial downlink BWP to monitor and/or transmit also helps reducing the power consumption.

It is to be understood that, the deactivating the active BWP by the terminal device means that the active BWP is in an inactive state, i.e. the terminal device no longer uses the BWP.

In a possible embodiment, the terminal device switches from the active BWP to the default downlink BWP or the initial downlink BWP when the timer expires and there is no other active BWP as follows. The terminal device switches from the active BWP to the default downlink BWP indicated by the default downlink BWP-ID when the terminal device is configured with the default downlink BWP-ID, the timer expires, and there is no other active BWP.

Since the terminal device is configured with the default downlink BWP-ID by the network device, the active BWP is not the default downlink BWP indicated by the default downlink BWP-ID, and the terminal device may switch to the default downlink BWP indicated by the default downlink BWP-ID when the timer expires and there is no other active BWP, thereby realizing the switching of one or more active BWPs. In this way, the terminal device continues the transmission of data on the default downlink BWP, thereby reducing the power consumption of the terminal device.

In another possible embodiment, the terminal device switches from the active BWP to the default downlink BWP or the initial downlink BWP when the timer expires and there is no other active BWP as follows. The terminal device switches from the active BWP to the initial downlink BWP when the terminal device is not configured with the default downlink BWP-ID, the timer expires, and there is no other active BWP.

Since the terminal device is not configured with the default downlink BWP-ID, the active BWP is not the initial downlink BWP, and the terminal device may switch from one or more active BWPs to the initial downlink BWP when the timer expires and there is no other active BWP, thereby realizing the switching of one or more active BWPs. In this way, the terminal device continues the transmission of data on the initial downlink BWP, thereby maintaining the continuity of communication and reducing the power consumption of the terminal device.

In embodiments of the disclosure, when multiple BWPs in a cell are in an active state, the terminal device associates each of the multiple active BWPs in a cell with a timer, i.e. each active BWP is associated with a timer. For each active BWP, the terminal device deactivates the active BWP and switches to a default downlink BWP or an initial downlink BWP when the associated timer expires and there is no other active BWP. The terminal device deactivates the active BWP when the associated timer expires and there are other active BWPs. It may be seen that, the terminal device may associate an active BWP with a timer to realize the switching and/or deactivation of one or more active BWPs, thereby maintaining the communication continuity of the terminal device while taking into account the power consumption of the terminal device.

Referring to FIG. 4, FIG. 4 is a schematic structural diagram of an apparatus for BWP switching provided in embodiments of the disclosure. The apparatus for BWP switching is used in a terminal device. The apparatus 400 for BWP switching may include a processing unit 401.

The processing unit 401 is configured to start/restart a timer associated with multiple active BWPs in a cell when any active BWP of the multiple active BWPs satisfies a starting/restarting condition of the timer. The processing unit 401 is further configured to switch from the multiple active BWPs to a default downlink BWP or an initial downlink BWP when the timer expires.

In a possible embodiment, the processing unit 401 configured to switch from multiple active BWPs to the default downlink BWP or the initial downlink BWP when the timer expires, is configured to switch from the multiple active BWPs to the default downlink BWP indicated by a default downlink BWP-ID when the processing unit 401 is configured with the default downlink BWP-ID and the timer expires.

In another possible embodiment, the processing unit 401 configured to switch from multiple active BWPs to a default downlink BWP or an initial downlink BWP when the timer expires, is configured to switch from the multiple active BWPs to the initial downlink BWP when the processing unit 401 is not configured with the default downlink BWP-ID and the timer expires.

In a possible embodiment, the starting/restarting condition of the timer includes the following. A PDCCH indicating downlink assignment or uplink grant is received by the processing unit 401 on any active BWP of the multiple active BWPs, and an ongoing random access procedure associated with a serving cell is successfully completed upon reception of the PDCCH addressed to a C-RNTI or a G-RNTI by the processing unit 401, or no ongoing random access procedure associated with the serving cell exists. The PDCCH indicating downlink assignment or uplink grant is addressed to one of: a C-RNTI, a CS-RNTI, a G-RNTI, or a G-CS-RNTI.

In another possible embodiment, the starting/restarting condition of the timer includes the following. A PDCCH indicating downlink assignment or uplink grant is received by the processing unit 401 for any active BWP of the multiple active BWPs, and an ongoing random access procedure associated with a serving cell is successfully completed upon reception of the PDCCH addressed to a C-RNTI or a G-RNTI by the processing unit 401, or no ongoing random access procedure associated with the serving cell exists. The PDCCH indicating downlink assignment or uplink grant is addressed to one of: a C-RNTI, a CS-RNTI, a G-RNTI, or a G-CS-RNTI.

In another possible embodiment, the starting/restarting condition of the timer includes the following. A MAC PDU is transmitted in a configured uplink grant and a LBT failure indication is not received by the processing unit 401 from layers lower than an MAC layer, and an ongoing random access procedure associated with a serving cell is successfully completed upon reception of the PDCCH addressed to a C-RNTI or a G-RNTI by the processing unit 401, or no ongoing random access procedure associated with the serving cell exists.

In another possible embodiment, the starting/restarting condition of the timer includes the following. A MAC PDU is received by the processing unit 401 in a configured downlink assignment, and an ongoing random access procedure associated with a serving cell is successfully completed upon reception of the PDCCH addressed to a C-RNTI or a G-RNTI by the processing unit 401, or no ongoing random access procedure associated with the serving cell exists.

Optionally, the apparatus 400 for BWP switching may also include a communicating unit 402 configured to communicate with other communication devices.

The embodiment of the disclosure and the above embodiments of the method are based on the same idea, and bring the same technical effect. For specific principle, reference may be made to the description of the above embodiments of the method, which will not be repeated herein.

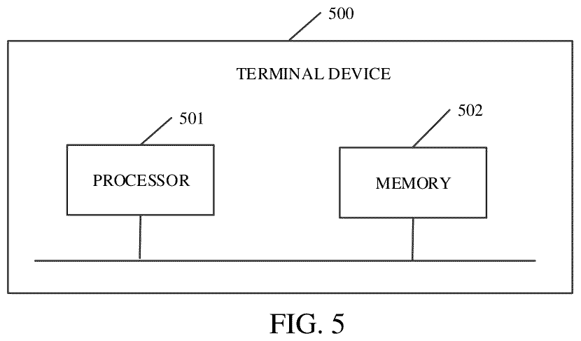

Referring to FIG. 5, FIG. 5 is a schematic structural diagram of a terminal device 500 provided in embodiments of the disclosure. The terminal device 500 may include a processor 501 and a memory 502. The processor 501 and the memory 502 are connected via one or more communication buses.

The processor 501 may be a central processing unit (CPU), or may be other general-purpose processors, a digital signal processor (DSP), an application specific integrated circuit (ASIC), a field-programmable gate array (FPGA), or other programmable logic devices, discrete gates or transistor logic devices, discrete hardware components, and the like. The general-purpose processor may be a microprocessor, or the processor may also be any conventional processor. The processor 501 is configured to support the terminal device to implement corresponding functions in the method described in FIG. 2 or FIG. 3.

The memory 502 may include a read-only memory (ROM) and a random access memory (RAM), and the memory 502 provides a computer program and data for the processor 501. A portion of the memory 502 may also include a non-volatile RAM. In a possible embodiment, the processor 501 is configured to execute the computer program to start/restart a timer associated with multiple active BWPs in a cell when any active BWP of the multiple active BWPs satisfies a starting/restarting condition of the timer, and to switch from the multiple active BWPs to a default downlink BWP or an initial downlink BWP when the timer expires.

The embodiment of the disclosure and the above embodiments of the method are based on the same idea, and bring the same technical effect. For specific principle, reference may be made to the description of the above embodiments of the method, which will not be repeated herein.

A chip is also provided in embodiments of the disclosure. The chip is configured to start/restart a timer associated with multiple active BWPs in a cell when any active BWP of the multiple active BWPs satisfies a starting/restarting condition of the timer, and configured to switch from the multiple active BWPs to a default downlink BWP or an initial downlink BWP when the timer expires.

For other embodiments of the chip, reference may be made to the corresponding illustrations in the foregoing method embodiments, which will not be described in detail again herein.

The embodiment of the disclosure and the above embodiments of the method are based on the same idea, and bring the same technical effect. Specific principle may refer to the description of the above embodiments of the method, which will not be repeated herein.

A module device is provided in embodiments of the disclosure. The module device includes a processor and a communication interface connected to the processor, and the communication interface is configured to transmit/receive signal. The processor is configured to start/restart a timer associated with multiple active BWPs in a cell when any active BWP of the multiple active BWPs satisfies a starting/restarting condition of the timer, and switch from the multiple active BWPs to a default downlink BWP or an initial downlink BWP when the timer expires.

For other embodiments of the module device, reference may be made to the corresponding illustrations in the foregoing method embodiments, which will not be described in detail again herein.

The embodiment of the disclosure and the above embodiments of the method are based on the same idea, and bring the same technical effect. Specific principle may refer to the description of the above embodiments of the method, which will not be repeated herein.

A non-transitory computer-readable storage medium is provided in embodiments of the disclosure. The storage medium stores a computer program, when executed by a processor, the methods of BWP switching described in embodiments of FIG. 2 or FIG. 3 may be implemented, which will not be repeated herein.

The non-transitory computer-readable storage medium may be an internal storage unit of the terminal device described in any of the foregoing embodiments, such as a hard disk or a memory of the device. The non-transitory computer-readable storage medium may also be an external storage device, such as a plug-in hard disk, a smart media card (SMC), a secure digital (SD) card, a flash card, or the like provided to the device. Further, the computer-readable storage medium may further include an internal storage unit and an external storage device. The computer readable storage medium may be configured to store the computer programs and other programs and data required by a terminal. The computer readable storage medium may be further configured to temporarily store data that has been output or will be output.

Those of ordinary skill in the art may understand that all or some of the procedures of the methods in the embodiments may be implemented by a computer program instructing relevant hardware. The program may be stored in a computer-readable storage medium. When the program runs, the procedures of the methods embodiments may be included. The storage medium may be a magnetic disk, an optical disk, a ROM, a RAM, or the like.

The above embodiments are only preferred embodiments of this disclosure, of course, the above embodiments cannot be used to limit the scope of this disclosure, and the equivalent changes made in accordance with the claims of this disclosure, still belong to the scope of the disclosure covered.

1. A method of bandwidth part (BWP) switching, comprising:
starting/restarting, by a terminal device, a timer associated with a plurality of active BWPs in a cell in response to any active BWP of the plurality of active BWPs satisfying a starting/restarting condition of the timer; and
switching, by the terminal device, from the plurality of active BWPs to a default downlink BWP or an initial downlink BWP in response to expiration of the timer.

2. The method of claim 1, wherein switching, by the terminal device, from the plurality of active BWPs to the default downlink BWP or the initial downlink BWP in response to expiration of the timer, comprises:
switching, by the terminal device, from the plurality of active BWPs to the default downlink BWP indicated by a default downlink BWP-identifier (ID) in response to the terminal device being configured with the default downlink BWP-ID and expiration of the timer.

3. The method of claim 1, wherein switching, by the terminal device, from the plurality of active BWPs to the default downlink BWP or the initial downlink BWP in response to expiration of the timer, comprises:
Switching, by the terminal device from the plurality of active BWPs to the initial downlink BWP in response to the terminal device not being configured with a default downlink BWP-identifier (ID) and expiration of the timer.

4. The method of claim 1, wherein the starting/restarting condition of the timer comprises:
a physical downlink control channel (PDCCH) indicating downlink assignment or uplink grant is received by the terminal device on any active BWP of the plurality of active BWPs, and
an ongoing random access procedure associated with a serving cell is successfully completed upon reception of the PDCCH addressed to a cell-radio network temporary identifier (C-RNTI) or a group-radio network temporary identifier (G-RNTI) by the terminal device, or no ongoing random access procedure associated with the serving cell exists,
wherein the PDCCH indicating downlink assignment or uplink grant is addressed to one of: a C-RNTI, a configured scheduling-radio network temporary identifier (CS-RNTI), a G-RNTI, or a configured scheduling-group-radio network temporary identifier (G-CS-RNTI).

5. The method of claim 1, wherein the starting/restarting condition of the timer comprises:
a PDCCH indicating downlink assignment or uplink grant is received by the terminal device for any active BWP of the plurality of active BWPs, and
an ongoing random access procedure associated with a serving cell is successfully completed upon reception of the PDCCH addressed to a C-RNTI or a G-RNTI by the terminal device, or no ongoing random access procedure associated with the serving cell exists,
wherein the PDCCH indicating downlink assignment or uplink grant is addressed to one of: a C-RNTI, a CS-RNTI, a G-RNTI, or a G-CS-RNTI.

6. The method of claim 1, wherein the starting/restarting condition of the timer comprises:
a medium access control (MAC) protocol data unit (PDU) is transmitted in a configured uplink grant and a listen before talk (LBT) failure indication is not received by the terminal device from layers lower than an MAC layer, and
an ongoing random access procedure associated with a serving cell is successfully completed upon reception of the PDCCH addressed to a C-RNTI or a G-RNTI by the terminal device, or no ongoing random access procedure associated with the serving cell exists.

7. The method of claim 1, wherein the starting/restarting condition of the timer comprises:
a MAC PDU is received by the terminal device in a configured downlink assignment, and
an ongoing random access procedure associated with a serving cell is successfully completed upon reception of the PDCCH addressed to a C-RNTI or a G-RNTI by the terminal device, or no ongoing random access procedure associated with the serving cell exists.

8-14. (canceled)

15. A method of bandwidth part (BWP) switching, comprising:
starting/restarting, by a terminal device, a timer associated with an active BWP in a cell in response to the active BWP satisfying a starting/restarting condition of the timer; and
switching, by the terminal device, from the active BWP to a default downlink BWP or an initial downlink BWP in response to expiration of the timer.

16. The method of claim 15, wherein switching, by the terminal device, from the active BWP to the default downlink BWP or the initial downlink BWP in response to expiration of the timer, comprises:
Switching, by the terminal device, from the active BWP to the default downlink BWP indicated by a default downlink BWP-identifier (ID) in response to the terminal device being configured with the default downlink BWP-ID and expiration of timer.

17. The method of claim 15, wherein switching, by the terminal device, from the active BWP to the default downlink BWP or the initial downlink BWP in response to expiration of the timer, comprises:
switching the terminal device from the active BWP to the initial downlink BWP in response to the terminal device not being configured with a default downlink BWP-identifier (ID) and expiration of the timer.

18. The method of claim 15, wherein the starting/restarting condition of the timer comprises:
a physical downlink control channel (PDCCH) indicating downlink assignment or uplink grant is received by the terminal device on the active BWP, and an ongoing random access procedure associated with a serving cell is successfully completed upon reception of the PDCCH addressed to a cell-radio network temporary identifier (C-RNTI) or a group-radio network temporary identifier (G-RNTI) by the terminal device, or no ongoing random access procedure associated with the serving cell exists,
wherein the PDCCH indicating downlink assignment or uplink grant is addressed to one of: a C-RNTI, a configured scheduling-radio network temporary identifier (CS-RNTI), a G-RNTI, or a configured scheduling-group-radio network temporary identifier (G-CS-RNTI).

19. The method of claim 15, wherein the starting/restarting condition of the timer comprises:
a PDCCH indicating downlink assignment or uplink grant is received by the terminal device for the active BWP, and
an ongoing random access procedure associated with a serving cell is successfully completed upon reception of the PDCCH addressed to a C-RNTI or a G-RNTI by the terminal device, or no ongoing random access procedure associated with the serving cell exists,
wherein the PDCCH indicating downlink assignment or uplink grant is addressed to one of: a C-RNTI, a CS-RNTI, a G-RNTI, or a G-CS-RNTI.

20. The method of claim 15, wherein the starting/restarting condition of the timer comprises:
a medium access control (MAC) protocol data unit (PDU) is transmitted in a configured uplink grant and a listen before talk (LBT) failure indication is not received by the terminal device from layers lower than an MAC layer, and
an ongoing random access procedure associated with a serving cell is successfully completed upon reception of the PDCCH addressed to a C-RNTI or a G-RNTI by the terminal device, or no ongoing random access procedure associated with the serving cell exists.

21. The method of claim 15, wherein the starting/restarting condition of the timer comprises:
a MAC PDU is received by the terminal device in a configured downlink assignment, and
an ongoing random access procedure associated with a serving cell is successfully completed upon reception of the PDCCH addressed to a C-RNTI or a G-RNTI by the terminal device, or no ongoing random access procedure associated with the serving cell exists.

22-29. (canceled)

30. A terminal device comprising:
a memory, connected to a processor, wherein the memory is configured to store a computer program and the computer program comprises a program instruction; and
the processor, wherein the processor is configured to execute the program instruction to;
start/restart, by a terminal device, a timer associated with an active BWP in a cell in response to the active BWP satisfying a starting/restarting condition of the timer; and
switch, by the terminal device, from the active BWP to a default downlink BWP or an initial downlink BWP in response to expiration of the timer.

31-36. (canceled)

37. The terminal device of claim 30, wherein in terms of switching, by the terminal device, from the active BWP to the default downlink BWP or the initial downlink BWP in response to expiration of the timer, the processor is configured to:
Switching, by the terminal device, from the active BWP to the default downlink BWP indicated by a default downlink BWP-identifier (ID) in response to the terminal device being configured with the default downlink BWP-ID and expiration of timer; or
switching the terminal device from the active BWP to the initial downlink BWP in response to the terminal device not being configured with a default downlink BWP-identifier (ID) and expiration of the timer.

38. The terminal device of claim 30, wherein the starting/restarting condition of the timer comprises:
a physical downlink control channel (PDCCH) indicating downlink assignment or uplink grant is received by the terminal device on the active BWP, and an ongoing random access procedure associated with a serving cell is successfully completed upon reception of the PDCCH addressed to a cell-radio network temporary identifier (C-RNTI) or a group-radio network temporary identifier (G-RNTI) by the terminal device, or no ongoing random access procedure associated with the serving cell exists,
wherein the PDCCH indicating downlink assignment or uplink grant is addressed to one of: a C-RNTI, a configured scheduling-radio network temporary identifier (CS-RNTI), a G-RNTI, or a configured scheduling-group-radio network temporary identifier (G-CS-RNTI).

39. The terminal device of claim 30, wherein the starting/restarting condition of the timer comprises:
a PDCCH indicating downlink assignment or uplink grant is received by the terminal device for the active BWP, and
an ongoing random access procedure associated with a serving cell is successfully completed upon reception of the PDCCH addressed to a C-RNTI or a G-RNTI by the terminal device, or no ongoing random access procedure associated with the serving cell exists,
wherein the PDCCH indicating downlink assignment or uplink grant is addressed to one of: a C-RNTI, a CS-RNTI, a G-RNTI, or a G-CS-RNTI.

40. The terminal device of claim 30, wherein the starting/restarting condition of the timer comprises:
a medium access control (MAC) protocol data unit (PDU) is transmitted in a configured uplink grant and a listen before talk (LBT) failure indication is not received by the terminal device from layers lower than an MAC layer, and
an ongoing random access procedure associated with a serving cell is successfully completed upon reception of the PDCCH addressed to a C-RNTI or a G-RNTI by the terminal device, or no ongoing random access procedure associated with the serving cell exists.

41. The terminal device of claim 30, wherein the starting/restarting condition of the timer comprises:
a MAC PDU is received by the terminal device in a configured downlink assignment, and
an ongoing random access procedure associated with a serving cell is successfully completed upon reception of the PDCCH addressed to a C-RNTI or a G-RNTI by the terminal device, or no ongoing random access procedure associated with the serving cell exists.
